(19) United States
(12) Patent Application Publication
(10) Pub. No.: US 2022/0198296 A1
(43) Pub. Date: Jun. 23, 2022

(54) USER CONTEXT MIGRATION BASED ON COMPUTATION GRAPH IN ARTIFICIAL INTELLIGENCE APPLICATION EXECUTING IN EDGE COMPUTING ENVIRONMENT

(71) Applicant: EMC IP Holding Comnpany LLC, Hopkinton, MA (US)

(72) Inventors: Jinpeng Liu, Shanghai (CN); Jin Li, Shanghai (CN); Zhen Jia, Shanghai (CN); Christopher S. MacLellan, Uxbridge, MA (US)

(21) Appl. No.: 17/132,344

(22) Filed: Dec. 23, 2020

(51) Int. Cl. G06N 5/04; G06N 20/00; H04L 29/08

(52) U.S. Cl. CPC G06N 5/04; H04L 67/18; H04L 67/1002; G06N 20/00

(57) ABSTRACT

In an information processing system with at least a first node and a second node separated from the first node, and each of the first node and the second node configured to execute an application in accordance with at least one entity that moves from a proximity of the first node to a proximity of the second node, a method maintains, as part of a context at the first node, a set of status indicators for a set of computations associated with a computation graph representing at least a portion of the execution of the application at the first node. Further, the method causes the transfer of the context from the first node to the second node to enable the second node to continue execution of the application using the transferred context from the first node.

### FIELD

The field relates generally to information processing systems, and more particularly to a artificial intelligence (AI) model management implemented in an information processing system.

### BACKGROUND

Edge computing, considered the evolution of cloud computing, migrates the deployment of applications (e.g., applications implementing AI models) from a centralized data center downward to distributed edge nodes, thereby achieving shorter distances from data generated by consumers and the applications. Edge computing is also considered an important technology for meeting 3GPP 5G key performance indicators (especially in terms of minimized delays and increased bandwidth efficiency). The 3GPP 5G system specification allows a multi-access edge computing (MEC) system and a 5G system to cooperate in operations related to traffic direction and policy controls. The MEC system is a European Telecommunications Standards Institute (ETSI) defined architecture that offers application developers and content providers cloud-computing capabilities and an information technology service environment at the edge of a network, e.g., at the edge of a cellular network such as a 5G system. In a system architecture where a 5G system and a MEC system are deployed in an integrated manner, a data plane of a 5G core network can be implemented by a user plane function network element inside the MEC system. However, due to the mobility of system users from one edge node to another, MEC implementation can present challenges.

For example, user context (i.e., information representing one or more internal execution states of an application) migration is a basic requirement defined in a MEC system for applications running in an edge computing environment. Such migration is needed to implement an application mobility service (AMS) so that the MEC architecture can migrate the application from one edge node to another edge node to follow the geographic position of the user equipment and thereby perform computations closer to the data source. However, when an application is complex, for example, one that employs an AI model (such as, but not limited to, machine learning (ML) applications, deep learning (DL) applications, and data mining (DM) applications), user context migration is a significant challenge.

### SUMMARY

Embodiments provide techniques for user context migration of an application in an information processing system such as, but not limited to, user context migration of an artificial intelligence-based application in an edge computing environment.

According to one illustrative embodiment, in an information processing system with at least a first node and a second node separated from the first node, and each of the first node and the second node being configured to execute an application in accordance with at least one entity that moves from a proximity of the first node to a proximity of the second node, a method maintains, as part of a context at the first node, a set of status indicators for a set of computations associated with a computation graph representing at least a portion of the execution of the application at the first node. Further, the method causes the transfer of the context from the first node to the second node to enable the second node to continue execution of the application using the transferred context from the first node.

In further illustrative embodiments, the maintaining step may further comprise setting each of the set of status indicators for the set of computations to one of a plurality of statuses based on an execution state of each of the computations, wherein a first status of the plurality of statuses represents that the given computation is completed, a second status of the plurality of statuses represents that the given computation has started but not yet completed, and a third status of the plurality of statuses represents that the given computation has not yet started.

Advantageously, in illustrative MEC-based embodiments, a context migration solution is provided that can be integrated into any deep learning frameworks, to run any AI models, with any processing parallelisms, for both inference and training applications.

These and other features and advantages of embodiments described herein will become more apparent from the accompanying drawings and the following detailed description.

### BRIEF DESCRIPTION OF THE DRAWINGS

FIG. 1 illustrates an application mobility service of a multi-access edge computing system with which one or more illustrative embodiments can be implemented.

FIG. 2 illustrates a high-level information flow associated with an application mobility service of a multi-access edge computing system with which one or more illustrative embodiments can be implemented.

FIG. 3 illustrates a workflow for an artificial intelligence framework for runtime execution of an artificial intelligence model with which one or more illustrative embodiments can be implemented.

FIG. 4A illustrates an exemplary ordering for which a scheduler of an artificial intelligence framework calls kernel computations associated with a computation graph using data parallelism.

FIG. 4B illustrates an exemplary ordering for which a scheduler of an artificial intelligence framework calls kernel computations associated with a computation graph using model parallelism.

FIG. 4C illustrates an exemplary ordering for which a scheduler of an artificial intelligence framework calls kernel computations associated with a computation graph using pipeline parallelism.

FIG. 5 illustrates an edge inference application model for a plurality of mobile user equipment of a telecommunications network with which one or more illustrative embodiments can be implemented.

FIG. 6 illustrates a process for obtaining a computation graph from different artificial intelligence frameworks and models according to an illustrative embodiment.

FIG. 7 illustrates a process for re-constructing a computation graph from an intermediate representation according to an illustrative embodiment.

FIG. 8 illustrates a process for obtaining a computation graph by parsing according to an illustrative embodiment.

FIG. 9 illustrates different computation scheduling schemes for different types of parallelism with which one or more illustrative embodiments can be implemented.

FIG. 10 illustrates a process for binding user equipment inputs to different scheduling schemes according to an illustrative embodiment.

FIG. 11 illustrates migration points defined for user context migration according to an illustrative embodiment.

FIG. 12 illustrates a process for migrating inference instances and user equipment from a source edge node to a target edge node according to an illustrative embodiment.

FIG. 13 illustrates a process for reversing a computation graph according to an illustrative embodiment.

FIG. 14 illustrates a methodology for migrating user context of an artificial intelligence-based application in an edge computing environment according to an illustrative embodiment.

FIG. 15 illustrates a processing platform used to implement an information processing system with user context migration functionalities according to an illustrative embodiment.

### DETAILED DESCRIPTION

Illustrative embodiments will now be described herein in detail with reference to the accompanying drawings. Although the drawings and accompanying descriptions illustrate some embodiments, it is to be appreciated that alternative embodiments are not to be construed as limited by the embodiments illustrated herein. Furthermore, as used herein, the term “includes” and its variants are to be read as open-ended terms that mean “includes, but is not limited to.” The term “based on” is to be read as “based at least in part on.” The term “an embodiment” and “the embodiment” are to be read as “at least one example embodiment.” The terms “first,” “second,” and the like may refer to different or the same objects. Other definitions, either explicit or implicit, may be included below.

The growth of artificial intelligence (AI) models, such as a machine learning (ML) application, a deep learning (DL) application, and/or a data mining (DM) application, has resulted in a single computing device being unable to execute the entire AI model independently. It is to be understood that AI models typically have two stages: training and inference. Training refers to the process of creating the AI model based on training data, while inference refers to the process of using the AI model (trained in the training process) to generate a prediction (decision) based on input data. The concept of parallelism, e.g., model parallelism, data parallelism or pipeline parallelism, is employed to execute a large complicated AI model. Data parallelism is where each computing device in the computing environment has a complete copy of the AI model and processes a subset of the training data. For model parallelism, the AI model is split (partitioned) among computing devices such that each computing device works on a part of the AI model. Pipeline parallelism is, for example, where the AI model and/or data is concurrently processed across a set of multiple computing cores (central processing units (CPUs), graphic processing units (GPUs), combinations thereof, etc.) within one or more computing devices.

By way of further example, in the context of model parallelism approaches, artificial (dummy) compiler techniques have been proposed for collecting resource requirements of each computing device, as well as model parallelism partition techniques based on an intermediate representation (IR) that divide the entire model into partitions which can then be computed in parallel by multiple computing devices which also exchange parameters between one another. Further, techniques have been proposed for scheduling the partitions into computing devices in a load-balanced manner based on resource requirements of the computation and other resources available on the devices. For example, techniques have been proposed for scheduling partitions for execution and balancing the computing and memory storage loads based on the resources available on the computing devices. Some of these proposed techniques are implementable for training of large models in GPUs distributed in multiple computing nodes in a cloud computing environment.

Furthermore, techniques have been proposed to provide a framework for implementing AI parallelism in an edge computing environment. As mentioned above, edge computing is a distributed computing paradigm and typically comprises one or more edge servers running one or more application programs that interact with a plurality of heterogeneous computing devices (e.g., X86_64/ARM CPUs (central processing units), FPGAs (field programmable gate arrays), ASICs (application specific integrated circuits), programmable switches, etc.) which are normally computing resource-limited (e.g., limited in terms of processing and/or storage capacities).

In addition, edge computing is an emerging technology developing together with emerging 5G (3GPP 5^{th} Generation) telecommunication network technology (MEC system) and equipped with many deep learning inference applications for autonomous driving, mobile mixed reality, drone pilot, smart home, Internet of Things (IoT) and virtual reality (VR) games, to name a few. Such applications typically need real-time responses or computing offload from servers, which cannot be adequately fulfilled by current cloud computing infrastructure. Thus, the emergence of edge computing is in response to the inability of centralized data centers to provide real-time or near-real-time compute capabilities to the vast (and growing) sources of decentralized data (so-called data “out in the wild”). Edge computing moves the computer workload closer to the consumer/data generator to reduce latency, bandwidth and overhead for the centralized data center and intermediate switches, gateways, and servers.

Furthermore, it is realized that a deep learning program can be developed by different frameworks to run different AI models, as well as use different parallelisms such as the above-mentioned data parallelism, model parallelism, and pipeline parallelism, wherein each will manage the computations differently. Also, an AI model usually has many computations and therefore a very complex user (application internal) context, especially when accelerators (e.g., GPUs) are used in the computing environment.

Hence, it is realized that, although managing the user context migration for an inference application (i.e., an AI model in the inference stage) is critical and meaningful, it is realized that an efficient implementation is very difficult to achieve in a real-time manner. By way of one example scenario to illustrate such real-time difficulty, assume a MEC system comprises an autonomous vehicle (auto-driving) system that employs an inference application running periodically on an edge node of an edge computing environment. The edge node serves multiple vehicles and each vehicle sends input data to the inference application. However, as vehicles move geographically closer to other edge nodes in the edge computing environment, it becomes necessary to migrate user context (i.e., information representing one or more internal execution states of an application) from one edge node to at least another edge node that is geographically closer to the vehicles. Existing systems are unable to efficiently handle this user context migration requirement.

Illustrative embodiments overcome the above and other drawbacks by providing solutions to efficiently migrate the user context of an application in an edge computing environment. Such solutions can be readily integrated into any frameworks to run any models with any types of parallelisms, not only for the inference stage but also for the training stage, based on the computation graph defined by an AI model. One or more embodiments can be integrated into commercially-available AI bundles (e.g., server, storage, networking platforms available from Dell Technologies Inc. of Hopkinton, Mass.), or applied to any private or public edge computing platform.

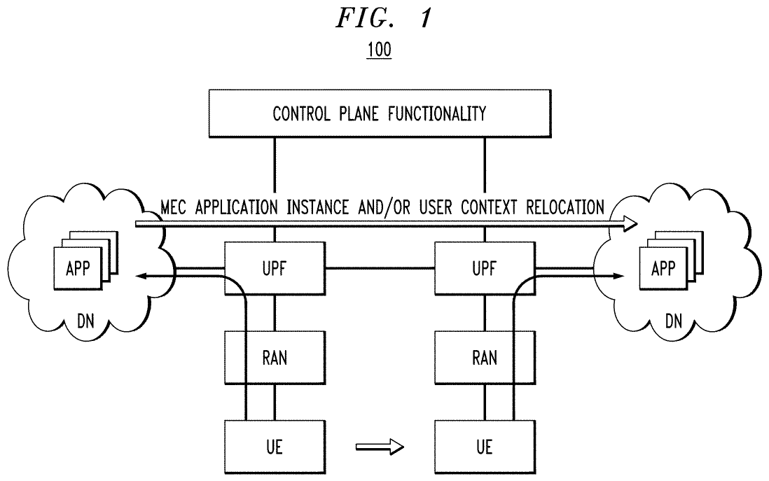

FIG. 1 illustrates an application mobility service (AMS) of a MEC system with which one or more illustrative embodiments can be implemented. More particularly, FIG. 1 shows a MEC system architecture 100 as set forth in the European Telecommunications Standards Institute (ETSI) White Paper No. 28, MEC in 5G Networks, June 2018, the disclosure of which is incorporated by reference in its entirety. In an edge computing environment, an application sometimes needs to be migrated from one MEC node to another to follow the user's geographic position so as to be computing closer to the data. As the ETSI references states, in reference to FIG. 1, when a UE (user equipment) is roaming from one RAN (radio access network) to another RAN, the serving application (application instance and/or user context) needs to be migrated from one DN (data network) to the new target DN to follow the UE position. In most circumstances, this means migration from one edge node to another edge node. After that, MEC will reselect the UPF (user plane function) between the UE and the target application. Due to the network bandwidth and real-time restrictions on the edge computing environment, the CRIU (checkpoint/restore in user-space) solution used in the cloud computing environment (cloud) to migrate the VM (virtual machine), container, or pod will not help there.

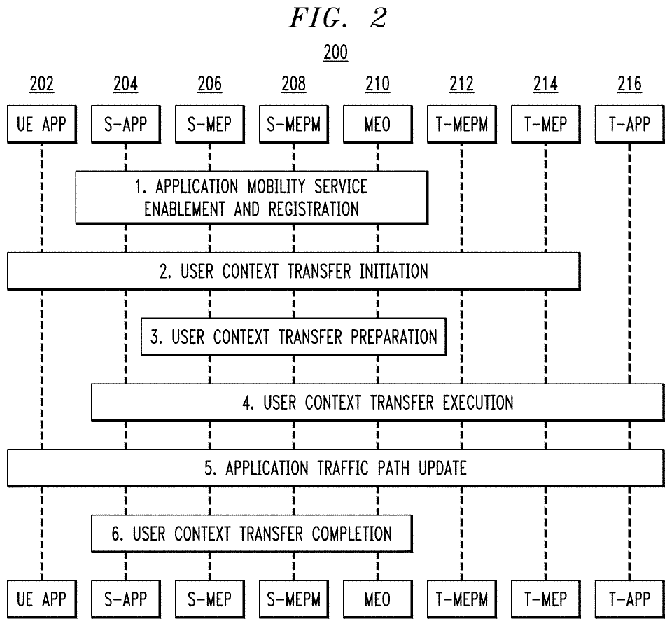

Hence, an application mobility service (AMS) is provided by the MEC system to optimize the migration process and help the applications to migrate the application instance and internal user context, as shown in the high-level information flow 200 in FIG. 2, taken from the MEC AMS Specification entitled ETSI GS MEC 021 Application Mobility Service API V2.1.1, 2020-01, the disclosure of which is incorporated by reference in its entirety.

As shown in FIG. 2, the MEC system information flow environment comprises a UE application (UE App) 202, a source application instance (S-APP) 204, a source MEC platform (5-MEP) 206, a source MEC platform manager (S-MEPM) 208, a mobile edge orchestrator (MEO) 210, a target MEC platform manager (T-MEPM) 212, a target MEC platform (T-MEP) 214, and a target application instance (T-App) 216. Source refers to a source edge node, while target refers to a target edge node.

As explained in the above-referenced ETSI standard, the MEC system is able to detect that a UE is going to roam away from the current RAN and predicts the destination RAN this UE will roam into by listening to the notifications sent from the 5G network. Hence, the MEC system is able to send appropriate notifications (1 to 6 in FIG. 2) accordingly to the application. From the application point of view, the application need not be concerned about the changing of network conditions (the MEC system acts on its behalf). Rather, the application need only provide the implementations to notifications (1 to 6 in FIG. 2) so that the MEC system can call these implementations at appropriate points to respond to the notifications. And after all implementations to the six notifications are finished, the AMS is achieved.

From FIG. 2, it is evident that to implement AMS, besides the application instance and user context transfer, the application needs to respond to the common notifications also, i.e., notification 1 to register the AMS to MEC and notification 5 to update the traffic path are common services, which are used frequently in a MEC-enabled application. Proposals have been provided for implementing such common services. Because these implementations are only responding to the MEC notifications and have nothing to do with the application internals, the same ideas can apply to all applications. Further, the application instance migration is managed automatically by MEC (e.g., at least in part by MEO 210). Proposals have been provided for an optimized implementation of the instance migration of a model parallelism inference application by identifying the user mobility use cases and by distinguishing different computing nodes inside the computation graph. However, to implement AMS, it is realized that one remaining task is to migrate the user context between the application instances running in the source edge node and the target edge node. Illustrative embodiments provide solutions for achieving this task as well as other tasks.

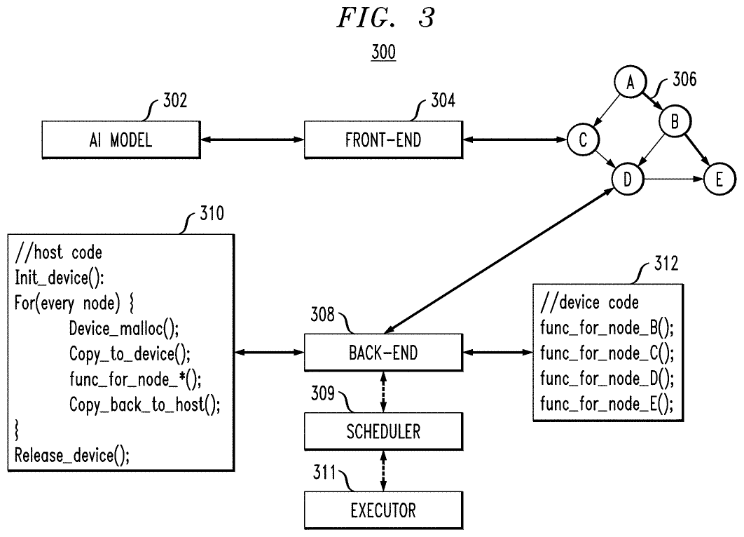

Runtime environments for provider-specific deep learning frameworks, for example, Tensorflow, PyTorch, or Keras, have a similar workflow which is illustrated in FIG. 3. More particularly, the main components of a deep learning framework runtime as illustrated in workflow 300 function as follows. An AI model 302, such as a Keras deep learning program, is presented to a framework compiler front-end 304 that compiles the program into an intermediate representation (IR) and corresponding computation graph 306 (e.g., static graph or dynamic graph). Each vertex (e.g., nodes A, B, C, D, E) in the computation graph 306 is a layer operator (e.g., convolution, activation, normalization, pooling, or softmax) defined by the deep learning framework, and each edge (arrow connecting nodes) defines the input/output dependency or producer/consumer relationship between two layers. Based on the computation graph 306, a framework compiler back-end 308 generates code for a scheduler 309 (host code 310) and kernel computations (device code 312).

More particularly, in one example, based on the vertexes in the computation graph 306, the framework compiler back-end 308 generates the implementations for all computation nodes (vertexes) by linking to third-party libraries such as cuDNN (Deep Neural Network) and cuBLAS (Basic Linear Algebra) for Nvidia GPU, Eigen library or BLAS for TensorFlow CPU, device drivers for proprietary accelerators such as TPU (Tensor Processing Unit), VTA (Versatile Tensor Accelerator) or ASICs, or directly generating the C function code for CPU or CUDA (Compute Unified Device Architecture) kernel functions. This implementation is JITed (Just-In-Time compiled) into binaries (i.e., binary representations of the vertexes of the computation graph) to be linked during the execution of the deep learning program. In a framework such as TVM (Tensor Virtual Machine), such computations can be compiled into a dynamically linked library to be deployed into computing devices in other computing nodes, with the computing devices being the same as the target when compiling the back-end binaries, i.e., cross-compilation. Based on the edges in the computation graph 306, the framework compiler back-end 308 generates scheduler code for the main CPU to schedule all kernel computations in order.

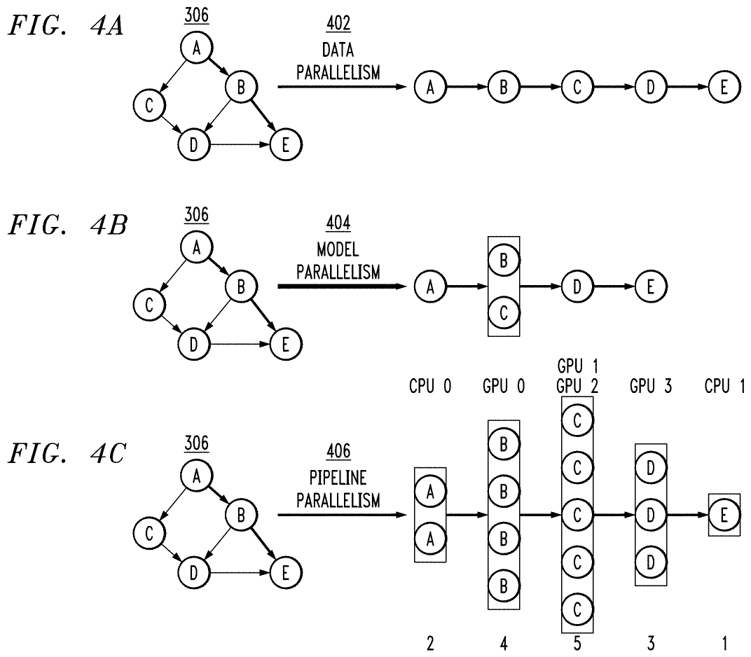

From FIG. 3, the following principles are realized herein. Whatever the deep learning framework is using for the deep learning application (e.g., Tensorflow, PyTorch, Keras, etc.), or whatever model is running (e.g., NLP, video, image classification, etc.), or if this model is used for inference or training (in training, there is an associated computation graph used in the back-propagation), there is always a computation graph inside the framework to guide the computation of the model. Furthermore, it is realized that whatever parallelism is used by the framework, the framework sorts the computation graph first into a linear data structure and, in the order defined in this linear data structure, all computations are executed. For example, in data parallelism, the sorting result of computation graph 306 (FIG. 3) is shown in FIG. 4A, so that the computations will be executed in order 402, i.e., A->B->C->D->E. Further, in model parallelism, the same computation graph 306 is sorted as shown in FIG. 4B, with an execution order 404 wherein computations B and C are executed in parallel. Still further, in pipeline parallelism, the same computation graph 306 is sorted as shown in FIG. 4C, with an execution order 406 wherein many instances of a computation can be executed inside the application for different input instances simultaneously.

Referring back to FIG. 3, scheduler 309 calls all kernel computations (functions) based on the given order (402, 404, 406), and for each of the kernel computations, the scheduler 309: (i) sets up the parameters of the call computation; (ii) if this computation is executed in an accelerator, copies the parameters from CPU memory onto the chip memory; (iii) causes execution of the kernel computation on the accelerator; and (iv) after computation, copies the results back from chip memory to the CPU main memory. Implementation details are slightly different in different provider-specific frameworks, for example, in TensorFlow, the input and output of a CUDA function are kept in the GPU to avoid parameter movement between the CPU and the GPU. But the principle is the same. After that, executor 311 executes scheduler code 312 in the main CPU to execute the network.

An edge inference application in a 5G network may serve one user equipment (UE) or a plurality of UEs at the same time, and such an application may have one or multiple process instances, hosted in a single or multiple edge nodes.

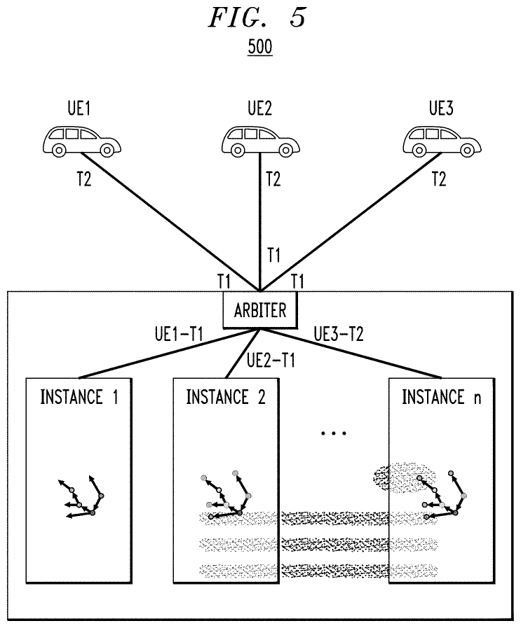

For example, in scenario 500 of FIG. 5, it is assumed that there are n instances of an inference application running in a single edge node to serve a plurality of 5G UEs, i.e., UE1, UE2 and UE3. Data from each UE is periodically sent through an arbiter to the inference application as input in a streamed manner. The inference application continuously computes the network based on this streamed time-series input, and outputs inference results (not expressly shown). For example, UE1 sends inputs T1 and T2 to the inference application periodically. However, it is assumed that UE1, UE2, and UE3 can send inputs to the inference application simultaneously.

Each data frame is an independent input to the inference application. For example, the T1 and T2 from UE1 are independent of each other and T1 from UE1 is independent of T1 sent from UE2. As shown, there are many parallel running inference instances for different input.

For example, the same inference application manages the feed-forward of iteration of all computations for input T1 from UE1 and another iteration for input T1 from UE2, so there are two inference instances for these two input instances simultaneously in the same inference application but each inference instance is independent of the other.

Given the illustrative FIG. 5 scenario and others, wherein many different applications and instances are running on edge nodes of an edge computing environment and each application has its different internal runtime states, current MEC implementations do not define how to efficiently migrate the application user context from one edge node to another. Adding to current MEC deficiencies is that fact that there are many different frameworks and many different models in deep learning applications. With different frameworks and different models, the internal runtime states of applications differ greatly. As such, it is realized that it is very difficult to provide a unified solution to migrate the user context of different applications. Furthermore, with the different parallelisms illustrated in FIGS. 4A through 4C, execution of the same model will result in different application runtime states thus making difficult a unified solution for all different parallelisms.

Still further, even with the same framework, the same model, and the same parallelism, an application scenario can use the model for training or inference. Differences between the training and the inference are as follows. For training, there is another associated computation graph used for back-propagation. Thus, for training, both inputs to the model (and hence the input to each layer operation) and the parameters inside the model will be changed from epoch to epoch, hence both need to be migrated during the user context migration. For inference, only the input to the model (and hence the input to each layer operation) will be changed from input instance to instance, hence only the input needs to be migrated during the user context migration.

As described above, as each inference instance for different inputs is independent of each other, there is an independent user context for each running instance for each input. Thus, during user context migration, these different states for different input instances need to be migrated independently.

Also, as described above, due to the restrictions of network bandwidth and the application real-time response, although managing the user context migration for a deep learning application is critical and meaningful, efficient implementation is very difficult especially in real-time applications such as an auto-driving system.

Illustrative embodiments overcome the above and other drawbacks with user context migration by fixing (e.g., setting, selecting, establishing, prescribing, and the like) a computation model to be used to generate an order for executing computations in response to determining the input model from a first plurality of selectable input models and the AI (e.g., deep learning) framework from a second plurality of selectable AI frameworks.

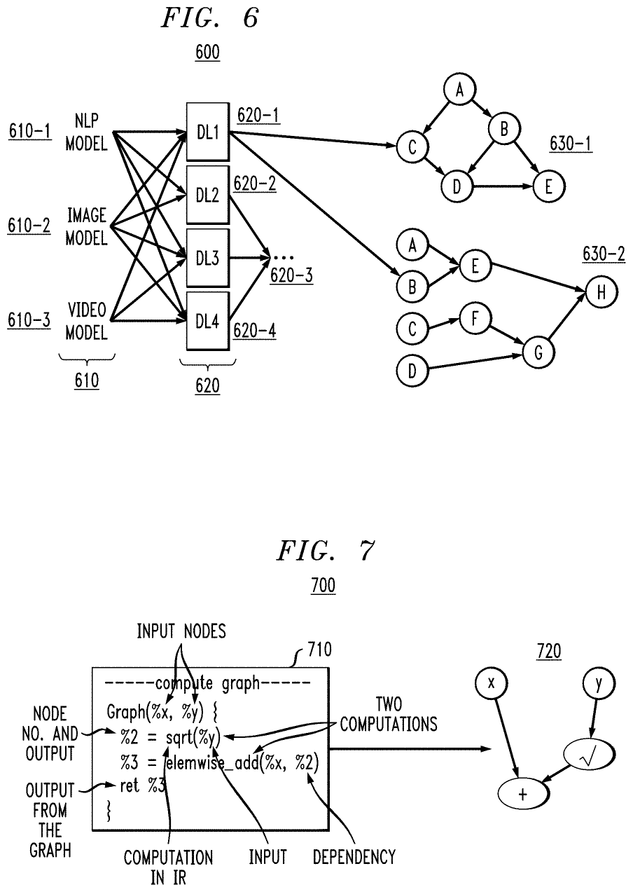

More particularly, FIG. 6 illustrates a process 600 for obtaining a computation graph from different AI frameworks and models according to an illustrative embodiment. As illustrated in FIG. 6, each one of a first plurality of AI models 610 (natural language processing (NLP) model 610-1, image model 610-2, video model 610-3) is able to execute on each one of a second plurality of deep learning frameworks 620 (DL1 620-1, DL2 620-2, DL3 620-3, DL4 620-4). Examples of the deep learning frameworks include, but are not limited to, Tensorflow, PyTorch, Keras, MxNET, TVM, ONNX Runtime, OpenVINO, etc. Each of the first plurality of AI models 610 can be used for inference or training. Regardless of the model that is selected and the framework that is selected to run the selected model, illustrative embodiments realize that there is a computation graph defined by the framework to guide the computation of the model. That is, each framework generates a different computation graph for each different model. Once the input model and the framework are fixed, the generated computation graph is also fixed. Process 600 obtains this computation graph from the framework and establishes it as the fixed computation graph. An example of a fixed computation model is shown in FIG. 6 as 630-1. Recall, in a training stage, there is also an associated computation graph to be used in the back-propagation process. Thus, an example of a fixed back-propagation computation graph is shown in FIG. 6 as 630-2.

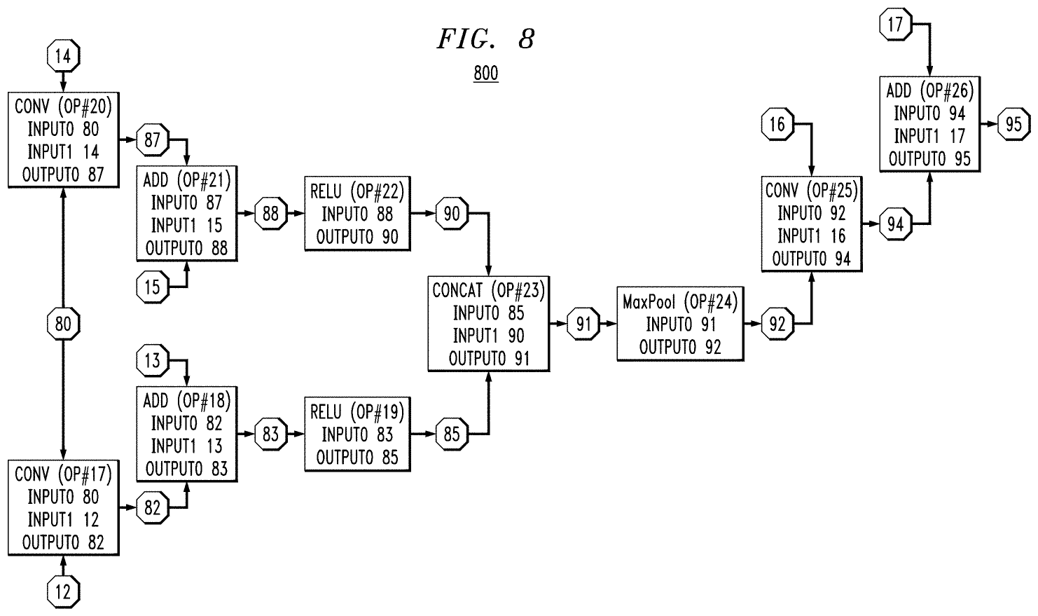

There are many suitable ways to obtain the computation graph from the selected deep learning framework (e.g., 620-1 as illustrated). By way of example only, the computation graph can be reconstructed from an intermediate representation (IR). FIG. 7 illustrates an example 700 of computation graph reconstruction from the IR. In particular, FIG. 7 shows a TVM IR 710 and a computation graph 720 that is reconstructed from elements and information associated with the TVM IR 710. By way of a further example, FIG. 8 shows a computation graph 800 obtained from the ONNX framework by parsing a protocol buffer file (protobuf) associated with a squeeze-net neural network model. Note that these are just two examples of many ways to obtain the computation graph from the model framework.

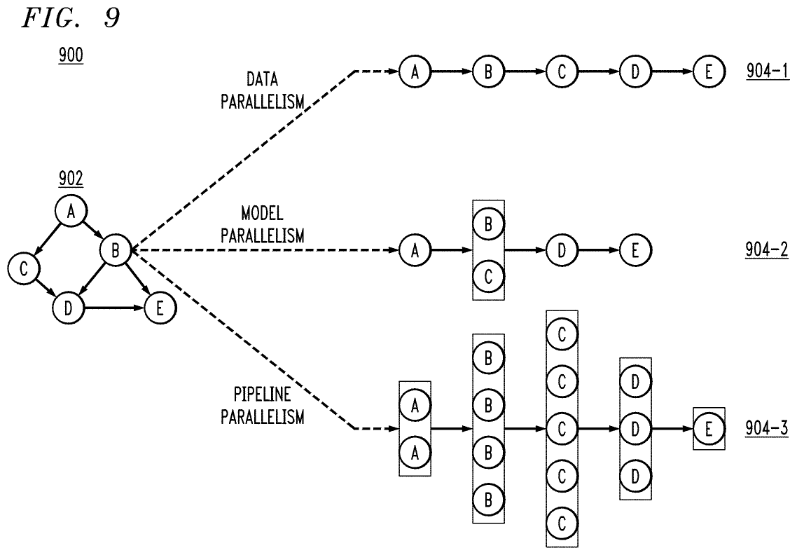

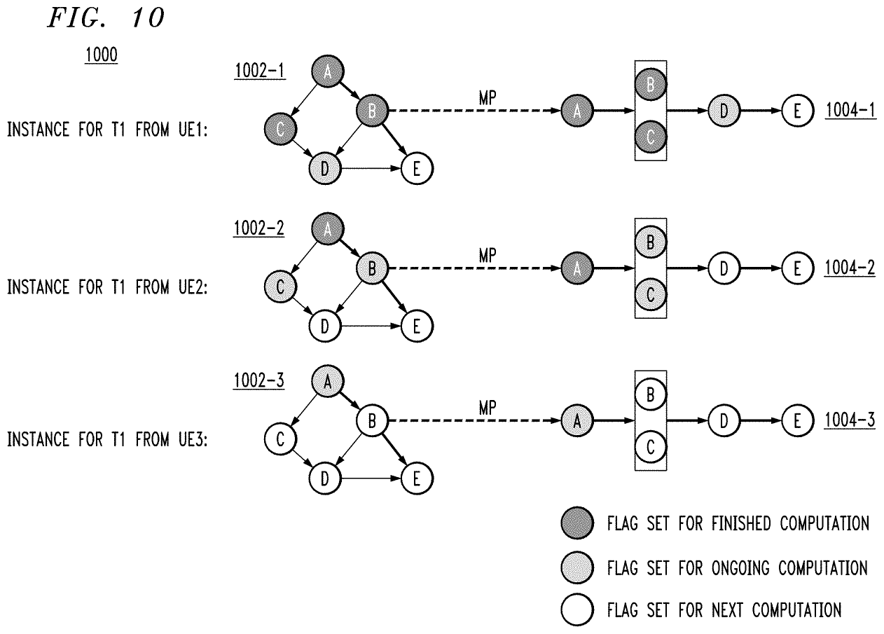

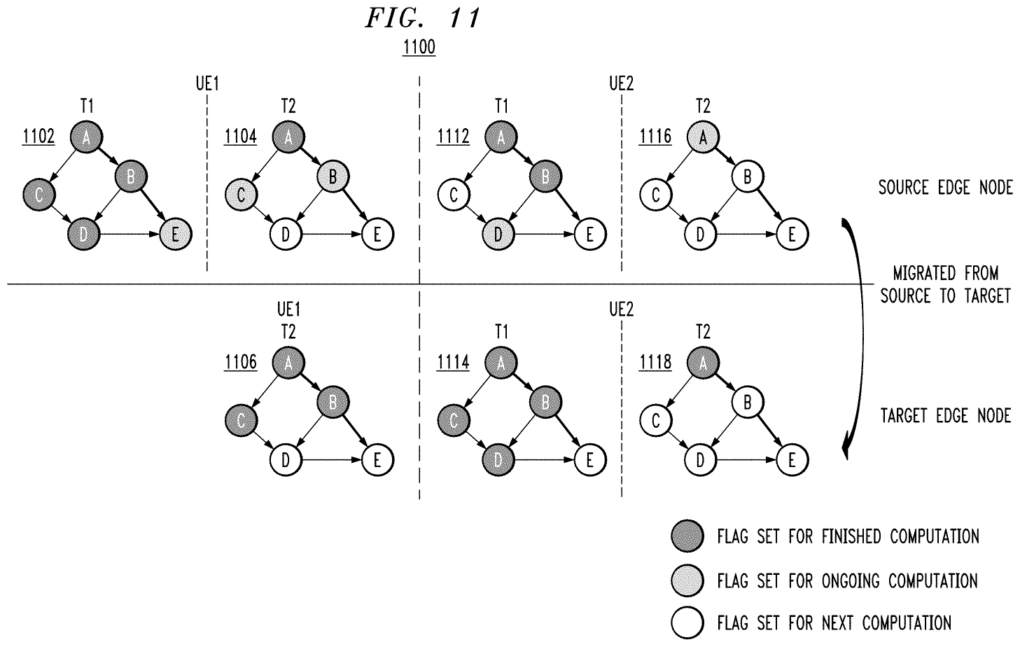

Once the computation graph is fixed, different types of parallelisms can be applied to schedule the computations. FIG. 9 shows a scenario 900 wherein different types of parallelism are applied to a computation graph 902 yielding different scheduling orders 904-1 (order resulting from data parallelism), 904-2 (order resulting from model parallelism), 904-3 (order resulting from pipeline parallelism). Thus, it is to be appreciated that, although different parallelisms will schedule computation in a fixed computation graph differently, once the parallelism is fixed, the computation scheduling scheme is fixed as well. That is, the scheduling scheme will not change with time or with different mini-batches or inference input instances to the model. Illustrative embodiments bind different computation instances to different inputs with different flags. As used herein, a flag refers to a data structure with a given value stored therein that acts as a signal for a function or process. More particularly, as used herein, the flags are examples of a set of status indicators which are settable to a plurality of statuses based on the execution state of a computation (as will be explained herein, FINISHED, ONGOING and NEXT). Thus, as will be further explained, each computation has a flag associated therewith that can be set to a given value within a range of values. It is to be appreciated that other types of data structures may be used in alternative embodiments to indicate the binding results described herein. FIG. 10 illustrates scenario 1000 for binding input T1 from UE1, UE2, and UE3 (recall FIG. 5) to three different scheduling scheme instances assuming the computation graph from FIG. 9 and model parallelism are used. More particularly, in FIG. 10, it is assumed that the inference application executing in a given edge node is serving three different input instances: T1 from UE1, T1 from UE2, and T1 from UE3. As these input instances are reaching the application at different times, the run-time states for these input instances are different also:
(1) The execution of the inference instance for T1 from UE1:
   assume the computations A, B, and C are finished, for which the flags corresponding to these computations are set to FINISHED (marked with medium grey shading (see legend at bottom of FIG. 10) in in computation graph 1002-1 and scheduling scheme instance 1004-1);
   assume the computation D is ongoing, for which the flag corresponding to computation D is set to ONGOING (marked with light grey shading in computation graph 1002-1 and scheduling scheme instance 1004-1); and
   assume the computation E is not reached yet but directly depends on ONGOING computation D, for which the flag corresponding to computation E is set to NEXT (marked with dark grey shading in computation graph 1002-1 and scheduling scheme instance 1004-1).
(2) The states for T1 from UE2 and UE3 are similarly flagged in their computation graphs 1002-2 and 1002-3, respectively, and scheduling scheme instances 1004-2 and 1004-3, respectively.

For implementation optimization, it is not necessary to use a computation graph or a computation scheduling scheme instance for each input, but rather all (or at least multiple) instances can share the same computation graph and scheduling scheme instance with different sets of flags on each instance. Advantageously, the runtime state for different input instances (e.g., mini-batches for training and input instances for inference) are defined by the flags (FINISHED, ONGOING, and NEXT) set for the computation graph and the computation scheduling scheme instance.

In accordance with illustrative embodiments, migration points are defined (i.e., as migration definitions or rules) as follows:
(i) Only migrate the computations when all ONGOING computations are FINISHED and only migrate computations whose states are NEXT. As such, an inference instance of a certain UE can be migrated from a source edge node to a target edge node.
(ii) Only after all instances of a given UE are migrated, can the given UE be migrated from a source edge node to a target edge node.

Rationale for point (i) is that migrating the user context of a running (ONGOING) computation is very inefficient and time-consuming, especially if it is executed in an accelerator (e.g., GPU), as it will migrate all main CPU machine states, the current registers, the function stack and sometimes needs to copy the parameters from the accelerator to the main CPU memory. In addition, sometimes it is not possible to resume the computation, for example, if a computation is executed inside a GPU, there is no way to resume the unfinished computation at another GPU.

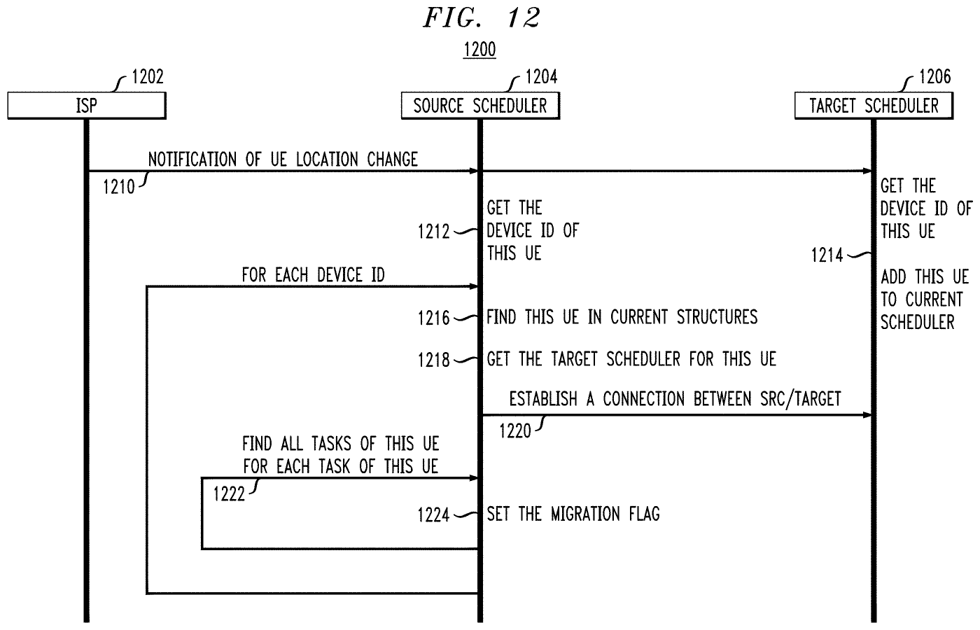

FIG. 11 illustrates an example 1100 of migration points defined for user context migration according to an illustrative embodiment. More particularly, as shown, it is assumed that there are two UEs, UE1 and UE2, each with two associated input instances T1 and T2. Also, note that the same grey-shading legend used in FIG. 10 is used in FIG. 11 to denote the computation-status flag set for each computation in each associated computation graph. Before user context migration, as denoted by 1102, the inference instance of T1 from UE1 is running computation E and no NEXT computation is pending. After computation E is finished, the inference result is sent back to UE1 and this instance is finished and need not to be migrated. Furthermore, before user context migration, as denoted by 1104, the inference instance of T2 from UE1 is running computations B and C, and computation D and E are flagged as NEXT. After computations B and C are finished, this inference instance is migrated from the source edge node to the target edge node, as denoted by 1106. In the target edge node, the deep learning framework proceeds with this inference by executing computation D by setting the flag of it to ONGOING (not expressly shown).

After inference instance T2 from UE1 is migrated, there is no inference instance associated with UE1, so the UE1 can be migrated from the source edge node to the target edge node. It is to be understood that while migrating user context from a source edge node to a target edge node means transferring data from the source edge node to the target edge node, migrating the UE from the source edge node to the target edge node means that the UE is moving its association (e.g., communication session, security context, etc.) from the source edge node to the target edge node. One or more appropriate protocols for moving a UE association from one node to another can be employed.

A similar user context migration scenario occurs for instances T1 and T2 from UE2. Instance T1 from UE2 migrates from a source edge node to a target edge node as denoted by 1112 and 1114. Instance T2 from UE2 migrates from the source edge node to the target edge node as denoted by 1116 and 1118. After instances T1 and T2 from UE2 are migrated, the UE2 is migrated from the source edge node to the target edge node.

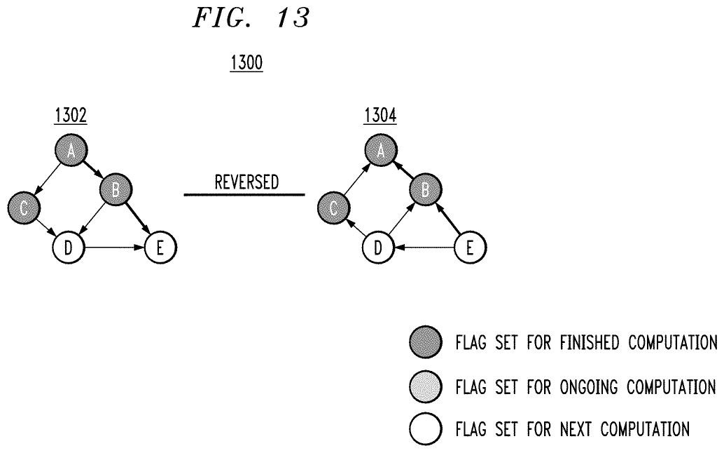

FIG. 12 below shows a workflow 1200 to migrate inference instances (user context) and a UE from a source edge node to a target edge node according to an illustrative embodiment. It is assumed that the source and target edge nodes are part of an edge computing environment managed by an internet service provider (ISP). As such, workflow 1200 shows an ISP component 1202 operatively coupled to a scheduler component of the source edge node, i.e., source scheduler 1204, and a scheduler component of the target edge node, i.e., target scheduler 1206.

As shown, in step 1210, ISP component 1202 sends notification of the subject UE location change to source scheduler 1204 and target scheduler 1206. In step 1212, source scheduler 1204 obtains the device identifier (ID) of the subject UE. Target scheduler 1206 does the same in step 1214 and adds this UE to its current scheduling operations.

For each device ID that is being managed by the source edge node, source scheduler 1204 finds the UE in current structures in step 1216. Source scheduler 1204 then determines the target scheduler for this UE in step 1218. In step 1220, a communication connection is established between the respective schedulers 1204 and 1206 of the source edge node and the target edge node. In step 1222, source scheduler 1204 determines all tasks (computations) of this UE, and for each task, sets the appropriate value for its computation-status (migration) flag in step 1224.

For implementation optimization, if a certain computation will take too long a time to be considered FINISHED to satisfy the real-time migration demand, the ONGOING computation can be stopped and set as a NEXT computation to let it be migrated to the target edge node to be restarted.

It is to be appreciated that, to this point, it is assumed that the computations in an inference instance that will be migrated to the target are known. As such, the next step is to find the parameters associated with the computations to be migrated.

From a deep learning network associated with an AI model, each layer can be expressed mathematically as:

Oₗ₊₁=σ(Wₗ₊₁×Oₗ+bₗ₊₁) (Eq. 1)

where Oₗ₊₁ and O₁ are the outputs of layer l+1 and layer l, σ is the activation function, Wₗ₊₁ and bₗ₊₁ are the parameters of layer l+1. From Eq. 1 above, it is evident that parameters to a certain computation can include: parameters such as Wₗ₊₁ and bₗ₊₁; and the output of other computations, e.g., the input to activation function a is the output of Wₗ₊₁×Oₗ and bₗ₊₁. So there are two type of parameters to each computation, i.e., the output from other computations and the model parameters. An illustrative explanation of how each type of parameter is handled will now be given.

### Handling the Output Parameters of Other Computations

The output of all computations will always change with different inputs. So all outputs from other computations input to NEXT computations need to be migrated.

To parse the output of other computations, the following information is determined:

(i) on which computations does the current computation depend (i.e., from which computations can the current computation get its input); and

(ii) where are the outputs of the dependent computations located.

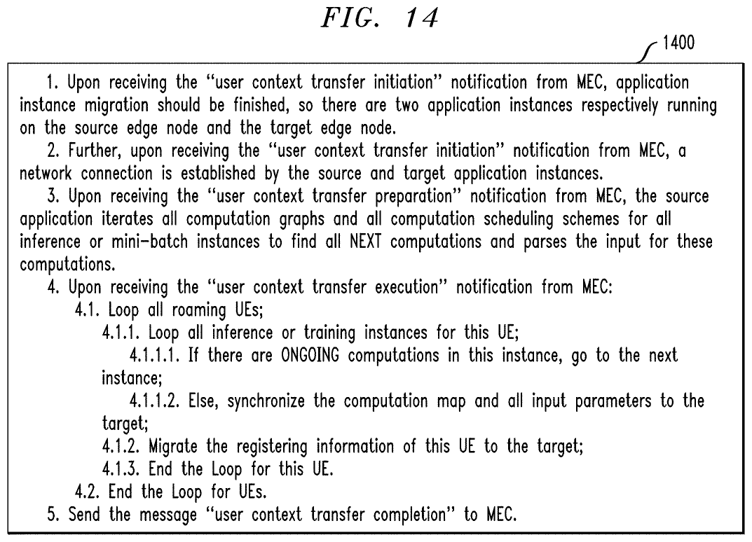

Information (i) can be determined by using a reversed computation graph. For example, to migrate the inference T2 of UE1 in FIG. 11, its computation graph is reversed as shown in process 1300 of FIG. 13 wherein the computation graph 1302 is reversed to obtain reversed computation graph 1304. In this example, a reversed graph is obtained by reversing input-output relationships between computations in the graph (i.e., visually represented by reversing the directions of the arrows connecting vertexes).

From the reversed computation graph 1304 it is evident that: the NEXT computation D depends on computations B and C, so the output B and C need to be migrated; and the NEXT computation E depends on computations B and D. As B has already migrated for computation D, and D is flagged as a NEXT computation without output, no parameters need to migrate for computation E.

Determining information (ii), i.e., where are these parameters located, is different from deep learning framework to deep learning framework. But for all frameworks, it is assumed they have IRs to indicate all parameters for all computation nodes. For example, in TVM, each output, input, and computation has a unique node number, and from this node number, it is readily determined where the output and input are located. By way of another example, in ONNX, the parameter for each computation can be determined by parsing the above-mentioned protobuf file.

### Handling the Model Parameters for Inference Applications

In inference applications, the model parameters will remain unchanged all the time once the training of this model is changed. To optimize the migration performance, the read-only model parameter can be treated as part of the application image and downloaded from the image repository. Therefore, no migration of the model parameters for inference applications is needed in such an illustrative embodiment.

### Handling the Model Parameters for Training Applications

For training applications, not only do the model parameters for all NEXT computations need to be migrated, but also the model parameters for all FINISHED computations as these parameters will be used in the training of the next mini-batch, otherwise all training results before the migration will be lost. Thus, in illustrative embodiments for a training application, instead of migrating model parameters computation by computation, all model parameters are migrated in one piece to improve network transportation performance. Typically, the size of the parameters of a model is very large, but on the other hand, training in an edge computing environment is not typical, and normally such applications have no real-time requirements. As such, this manner of handling the model parameters is acceptable.

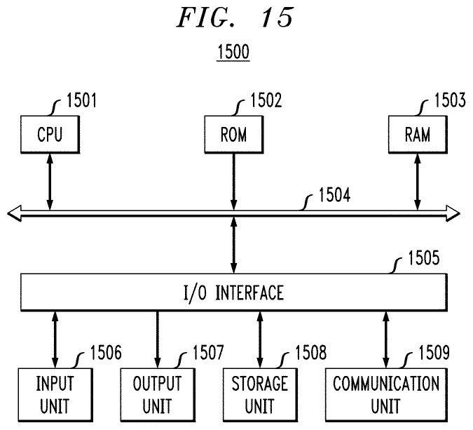

Given the above description of illustrative embodiments, migration of runtime states and computation input parameters (i.e., user context migration) can be implemented by adapting the above-described information flow 200 in FIG. 2 associated with AWS of a MEC system as defined in methodology 1400 of FIG. 14:

1. Upon receiving the “user context transfer initiation” notification (in step 2 of FIG. 2) from MEC, the application instance migration should be finished, so there are two application instances respectively running on the source edge node (i.e., S-App 204) and the target edge node (i.e., T-App 216).

2. Further, upon receiving the “user context transfer initiation” notification from MEC, a network connection is established by the source and target application instances (i.e., between S-App 204 and T-App 216).

3. Upon receiving the “user context transfer preparation” notification (in step 3 of FIG. 2) from MEC, the source application (i.e., S-App 204) iterates all computation graphs and all computation scheduling schemes for all inference or mini-batch instances to find all NEXT computations and parses the input for these computations.

4. Upon receiving the “user context transfer execution” notification (in step 4 of FIG. 2) from MEC:
4.1. Loop all roaming UEs;
   4.1.1. Loop all inference or training instances for this UE;
      4.1.1.1. If there are ONGOING computations in this instance, go to the next instance;
      4.1.1.2. Else, synchronize the computation map and all input parameters to the target;
   4.1.2. Migrate the registering information of this UE to the target;
   4.1.3. End the Loop for this UE.
4.2. End the Loop for UEs.

5. Send the message “user context transfer completion” (in step 6 of FIG. 2) to MEC Many advantages are realized in accordance with illustrative embodiments. For example, illustrative embodiments provide a solution for deep learning application user context transfer migration. More particularly, a unified solution is provided to transfer the user context of any deep learning application based on the AMS specification defined in the MEC standard. With such a solution, a deep learning application from any framework (e.g., TensorFlow, PyTorch, MxNET, Keras, etc.) to calculate any models (e.g., NLP, image classification, video processing, etc.), with any parallelisms (e.g., data parallelism, model parallelism, pipeline parallelism, etc.), running in an edge computing environment can be migrated between different MEC nodes to follow the user geographical position so as to compute closer to the data. It is to be appreciated that while illustrative embodiments are described herein in accordance with AWS/MEC, alternative embodiments of user context migration are not restricted to the MEC standard or AWS specification.

Further, illustrative embodiments provide a solution that can be integrated into any framework to run any model. As the solution is based on a fixed computation graph, instead of on application programming interfaces (APIs) provided by a framework, and a framework running a model is based on the computation graph, this solution can be easily integrated into any framework to run any model.

Still further, illustrative embodiments provide a solution that can be used for any type of parallelism. The difference between different parallelisms is the algorithm used inside the framework to sort the computation graph into a linear data structure. This linear data structure is the basis on which the scheduler schedules all computations. Once the computation graph and the parallelism are determined, the resultant linear data structure will not change with time and place, for example, it will not be changed during the migration from the source edge node to the target edge node. So how the scheduler schedules all computations are identical before and after the migration.

Illustrative embodiments also provide a solution that can be used for training and inference applications. The difference between migrating a training application and an inference application is how to migrate the model parameters. For the inference application, the model parameters are not migrated at all but rather downloaded directly from a repository during the application instance phase. For the training application, all model parameters are sent from the source to the target. In such a way, this solution supports user context transfer for both training and inference applications. Further, as this solution maintains the states of each inference instance independently, the solution can migrate multiple inference instances from the same or different UEs at the same time.

Illustrative embodiments are very efficient in both network transportation and execution. During the user context migration, only the states of each computation in the computation graph need to be synchronized, which normally is a very small data structure. For example, assume 1000 computations in a computation graph, and two bits are used for the state of each computation, then that results in about 250 bytes to be transferred. For the input parameters, depending on the parallelism degree, there may be four to eight computations which are in NEXT states. This means that there are four to eight vectors to be transferred. Again, model parameters can be directly downloaded from a repository for which, typically, the network latency is better than that of the edge network. Also, after all data are transferred, the application running on the target node is able to use these states seamlessly without any extra operations.

In summary, illustrative embodiments provide as solution that is very powerful, because it can be integrated into any frameworks, to run any models, with any parallelisms, for both the inference and training applications, yet it is very efficient because only a very small amount of data is transferred, without any extra processing for the user context migration.

FIG. 15 illustrates a block diagram of an example processing device or, more generally, an information processing system 1500 that can be used to implement illustrative embodiments. For example, one or more components in FIGS. 1-14 can comprise a processing configuration such as that shown in FIG. 15 to perform steps described above in the context of FIG. 5. Note that while the components of system 1500 are shown in FIG. 15 as being singular components operatively coupled in a local manner, it is to be appreciated that in alternative embodiments each component shown (CPU, ROM, RAM, and so on) can be implemented in a distributed computing infrastructure where some or all components are remotely distributed from one another and executed on separate processing devices. In further alternative embodiments, system 1500 can include multiple processing devices, each of which comprise the components shown in FIG. 15.

As shown, the system 1500 includes a central processing unit (CPU) 1501 which performs various appropriate acts and processing, based on a computer program instruction stored in a read-only memory (ROM) 1502 or a computer program instruction loaded from a storage unit 1508 to a random access memory (RAM) 1503. The RAM 1503 stores therein various programs and data required for operations of the system 1500. The CPU 1501, the ROM 1502 and the RAM 1503 are connected via a bus 1504 with one another. An input/output (I/O) interface 1505 is also connected to the bus 1504.

The following components in the system 1500 are connected to the I/O interface 1505, comprising: an input unit 1506 such as a keyboard, a mouse and the like; an output unit 1507 including various kinds of displays and a loudspeaker, etc.; a storage unit 1508 including a magnetic disk, an optical disk, and etc.; a communication unit 1509 including a network card, a modem, and a wireless communication transceiver, etc. The communication unit 1509 allows the system 1500 to exchange information/data with other devices through a computer network such as the Internet and/or various kinds of telecommunications networks.

Various processes and processing described above may be executed by the CPU 1501. For example, in some embodiments, methodologies described herein may be implemented as a computer software program that is tangibly included in a machine readable medium, e.g., the storage unit 1508. In some embodiments, part or all of the computer programs may be loaded and/or mounted onto the system 1500 via ROM 1502 and/or communication unit 1509. When the computer program is loaded to the RAM 1503 and executed by the CPU 1501, one or more steps of the methodologies as described above may be executed.

Illustrative embodiments may be a method, a device, a system, and/or a computer program product. The computer program product may include a computer readable storage medium having computer readable program instructions thereon for causing a processor to carry out aspects of illustrative embodiments.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of illustrative embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Various technical aspects are described herein with reference to flowchart illustrations and/or block diagrams of methods, device (systems), and computer program products according to illustrative embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor unit of a general purpose computer, special purpose computer, or other programmable data processing device to produce a machine, such that the instructions, when executed via the processing unit of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing device, or other devices to cause a series of operational steps to be performed on the computer, other programmable devices or other devices to produce a computer implemented process, such that the instructions which are executed on the computer, other programmable devices, or other devices implement the functions/acts specified in the flowchart and/or block diagram block or blocks.

The flowchart and block diagrams illustrate architecture, functionality, and operation of possible implementations of systems, methods and computer program products according to various embodiments. In this regard, each block in the flowchart or block diagrams may represent a module, snippet, or portion of code, which includes one or more executable instructions for implementing the specified logical function(s). In some alternative implementations, the functions noted in the block may occur out of the order noted in the figures. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
in an information processing system with at least a first node and a second node separated from the first node, and each of the first node and the second node configured to execute an application in accordance with at least one entity that moves from a proximity of the first node to a proximity of the second node;
maintaining, as part of a context at the first node, a set of status indicators for a set of computations associated with a computation graph representing at least a portion of the execution of the application at the first node; and
causing the transfer of the context from the first node to the second node to enable the second node to continue execution of the application using the transferred context from the first node;
wherein the first node comprises at least one processor and at least one memory storing computer program instructions wherein, when the at least one processor executes the computer program instructions, the first node performs the above steps.

2. The method of claim 1, wherein the maintaining step further comprises setting each of the set of status indicators for the set of computations to one of a plurality of statuses based on an execution state of each of the computations.

3. The method of claim 2, wherein a first status of the plurality of statuses represents that the given computation is completed.

4. The method of claim 3, wherein a second status of the plurality of statuses represents that the given computation has started but not yet completed.

5. The method of claim 3, wherein a third status of the plurality of statuses represents that the given computation has not yet started.

6. The method of claim 5, wherein the context is transferred from the first node to the second node after each computation with the second status is completed.

7. The method of claim 5, wherein the context transferred to the second node includes one or more computations with the third status.

8. The method of claim 5, wherein the maintaining step further comprises changing one or more computations with the second status to the third status prior to the one or more computations being completed, based on a timing demand associated with the context transfer step.

9. The method of claim 5, wherein the transferred context further comprises parameters associated with the set of computations.

10. The method of claim 9, wherein the parameters for a given computation comprise at least one of model parameters for the given computation and outputs from other computations.

11. The method of claim 10, wherein parameters that are outputs of other computations that serve as inputs to computations with the third status are transferred as part of the context.

12. The method of claim 9, wherein, when the application comprises an artificial intelligence model used for inference, no model parameters are necessarily part of the transferred context.

13. The method of claim 9, wherein, when the application comprises an artificial intelligence model used for training, model parameters of at least computations with the first status and the third status are part of the transferred context.

14. The method of claim 1, wherein the information processing system comprises an edge computing environment and the first node and second node respectively comprise two edge nodes of the edge computing environment, and the at least one entity comprises cellular-based user equipment that moves from a proximity of the first edge node to a proximity of the second edge node.

15. An apparatus, comprising:
at least one processor and at least one memory storing computer program instructions wherein, when the at least one processor executes the computer program instructions, the apparatus is configured as a first node in an information processing system with at least the first node and a second node separated from the first node, and each of the first node and the second node are configured to execute an application in accordance with at least one entity that moves from a proximity of the first node to a proximity of the second node, wherein the first node performs operations comprising:
maintaining, as part of a context at the first node, a set of status indicators for a set of computations associated with a computation graph representing at least a portion of the execution of the application at the first node; and
causing the transfer of the context from the first node to the second node to enable the second node to continue execution of the application using the transferred context from the first node.

16. The apparatus of claim 15, wherein the maintaining operation further comprises setting each of the set of status indicators for the set of computations to one of a plurality of statuses based on an execution state of each of the computations.

17. The apparatus of claim 16, wherein a first status of the plurality of statuses represents that the given computation is completed, a second status of the plurality of statuses represents that the given computation has started but not yet completed, and a third status of the plurality of statuses represents that the given computation has not yet started.

18. A computer program product stored on a non-transitory computer-readable medium and comprising machine executable instructions, the machine executable instructions, when executed, causing a processing device to perform steps of a first node in an information processing system with at least the first node and a second node separated from the first node, and each of the first node and the second node configured to execute an application in accordance with at least one entity that moves from a proximity of the first node to a proximity of the second node, wherein the first node performs steps comprising:
maintaining, as part of a context at the first node, a set of status indicators for a set of computations associated with a computation graph representing at least a portion of the execution of the application at the first node; and
causing the transfer of the context from the first node to the second node to enable the second node to continue execution of the application using the transferred context from the first node.

19. The computer program product of claim 18, wherein the maintaining step further comprises setting each of the set of status indicators for the set of computations to one of a plurality of statuses based on an execution state of each of the computations.

20. The computer program product of claim 19, wherein a first status of the plurality of statuses represents that the given computation is completed, a second status of the plurality of statuses represents that the given computation has started but not yet completed, and a third status of the plurality of statuses represents that the given computation has not yet started.
